(19) United States
(12) Patent Application Publication
(10) Pub. No.: US 2026/0296511 A1
(43) Pub. Date: Oct. 1, 2026

(54) Methods and Systems for Automatic Track Inspection and Evaluation

(71) Applicant: Intramotev Inc., St. Louis, MO (US)

(72) Inventors: Timothy John Franklin Luchini, Troy, IL (US); Briton Rand Bauerly, Kirkwood, MO (US); Daniel Pedraza, St. Louis, MO (US)

(21) Appl. No.: 19/092,921

(22) Filed: Mar. 27, 2025

(51) Int. Cl. B61L 23/04; B61L 25/02; G01S 13/88; G01S 17/89; G06T 7/00; G06V 10/82

(52) U.S. Cl. CPC B61L 23/042; B61L 25/025; G01S 13/885; G01S 17/89; G06T 7/0004; G06V 10/82

(57) ABSTRACT

Techniques and systems for automatic track inspection and evaluation are presented herein. An example system may initially receive sensor data related to track conditions of a railway track from one or more sensors coupled to a railway vehicle as the railway vehicle travels on the railway track. The system can use the sensor data to detect track issues associated with the railway track and then transmit information conveying the track issues associated with the railway track to a remote computing system. The remote computing system may aggregate information from computing devices distributed on various railway vehicles and use the aggregated information to perform actions that can enhance the safety and condition of the railway tracks to improve railway vehicle operations.

### FIELD

The present disclosure relates to railway track inspection and maintenance systems, and more particularly to automated track inspection and evaluation systems and track evaluation techniques that use sensor-equipped railway vehicles and machine learning algorithms to perform real-time track condition monitoring and predictive maintenance.

### BACKGROUND

Railway transportation systems play an important role in modern logistics and passenger travel. These systems rely heavily on the integrity and condition of the tracks to ensure safe and efficient operations. As such, regular inspection and maintenance of railway tracks can help prevent accidents, reduce downtime, and optimize the performance of trains.

Traditionally, track inspection has been carried out through manual visual inspections by trained personnel. This approach, while effective, can be time-consuming, labor-intensive, and subject to human error. Additionally, the increasing complexity and extent of railway networks make it challenging to conduct comprehensive inspections with the frequency needed to detect potential issues before they escalate into serious problems.

### SUMMARY

Example embodiments relate to techniques and systems for automatic track inspection and evaluation. These embodiments may involve using various sensors positioned on railway vehicles to collect data related to track conditions. The sensors, which may be retrofitted onto freight cars or other types of railway vehicles, may generate sensor data as the railway vehicles travel along a railway track. An onboard computing system or another type of data processing unit analyzes the sensor data to identify specific track issues, such as ballast washout, deteriorating rail ties, missing spikes, broken joints, warped/bent track, cracked track, and rail pitting. Analysis of the sensor data may involve using machine learning models, which can leverage different types of sensor data to locate and identify track conditions, predict and monitor progressive damage over time, and detect compliance with regulatory requirements, among other operations. In some cases, the computing system may also evaluate dynamics associated with traveling on the railway track relative to railway operation parameters to understand performance on the track across different factors, such as train car position, speed, track grade, and weather conditions.

In some examples, the processed sensor data and analysis results may be transmitted by an onboard computing system to other computing systems like a central dispatch or maintenance crews, enabling timely action and efficient maintenance planning. Based on the evaluation of track segments within a rail network, a central network system may implement automatic speed restrictions and weight limits for railway vehicles to follow and may also alternate routes or operational parameters used by the railway vehicles in some cases. These restrictions can be communicated to and utilized by various railway vehicles, enhancing overall safety and operational efficiency. This comprehensive approach to track inspection and evaluation allows for proactive maintenance and improved railway performance.

Accordingly, a first example embodiment describes a method. The method involves receiving, at a computing device, sensor data related to track conditions of a railway track from one or more sensors coupled to a railway vehicle as the railway vehicle travels on the railway track. The method further involves detecting, using the sensor data, one or more track issues associated with the railway track and transmitting information conveying the one or more track issues associated with the railway track to a remote computing system. The remote computing system is configured to aggregate information from a plurality of computing devices, and each computing device from the plurality of computing devices is coupled on a given railway vehicle.

Another example embodiment describes a system. The system includes one or more sensors coupled to a railway vehicle and a computing device. The computing device is configured to receive sensor data related to track conditions of the railway track from the one or more sensors as the railway vehicle travels on the railway track. The computing device is also configured to detect, using the sensor data, one or more track issues associated with the railway track and transmit information conveying the one or more track issues associated with the railway track to a remote computing system. The remote computing system is configured to aggregate information from a plurality of computing devices, and wherein each computing device from the plurality of computing devices is coupled on a given railway vehicle.

An additional example embodiment describes a non-transitory computer readable medium configured to store instructions, that when executed by a computing system comprising one or more processors, causes the computing system to perform operations. The operations involve receiving sensor data related to track conditions of a railway track from one or more sensors coupled to a railway vehicle as the railway vehicle travels on the railway track and detecting, using the sensor data, one or more track issues associated with the railway track. The operations also involve transmitting information conveying the one or more track issues associated with the railway track to a remote computing system. The remote computing system is configured to aggregate information from a plurality of computing devices, and each computing device from the plurality of computing devices is coupled on a given railway vehicle.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a functional block diagram illustrating a motive system for a railway vehicle, according to one or more example embodiments.

FIG. 2 is a functional block diagram illustrating a computing system, according to one or more example embodiments.

FIG. 3 is a configuration of a railway vehicle equipped with a motive system, according to one or more example embodiments.

FIG. 4 is another configuration of a railway vehicle equipped with a motive system, according to one or more example embodiments.

FIG. 5 is an additional configuration of a railway vehicle equipped with a motive system, according to one or more example embodiments.

FIG. 6 is a functional block diagram of a system for automatic track inspection and evaluation, according to one or more example embodiments.

FIG. 7 is a flowchart of a method for performing automatic track inspection and evaluation, according to one or more example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure relates to techniques and systems for automatic railway track inspection and evaluation. These systems and techniques provide a comprehensive solution for monitoring and assessing railway track conditions, which can then enable the performance of various actions that enhance railway vehicle operations and safety. For instance, disclosed techniques and systems may be used to promptly detect and identify track issues, enabling timely maintenance and repairs that can prevent minor problems from escalating into major failures. In some cases, some detected track issues may lead to rerouting trains to alternate tracks or lines to avoid problematic sections. In addition, periodic or continuous evaluation of the railway system can allow example systems to also assist in determining appropriate operation ranges (e.g., speed, weight) for railway vehicles to use when traveling different portions of the track network. Some examples may also evaluate track conditions during different weather conditions and temperatures, which can be recorded and factored when determining the routes, speed and weight limits, and other operations for railway vehicles to use when traveling on different tracks within the railway network.

Example systems and techniques described herein offer several advantages over existing track evaluation methods. Disclosed techniques and systems may leverage data from one or multiple types of sensors positioned on railway vehicles traveling along tracks, which may include freight cars or other vehicle types retrofitted with the sensors. This approach allows for seamless integration into current railway operations without requiring dedicated inspection vehicles or extensive fleet modifications. In addition, by utilizing sensors positioned on regular railway vehicles, example systems and techniques can enable continuous data generation and collection during normal railway vehicle operations, creating a constant stream of real-time information about track conditions. This continuous data generation and monitoring capability represents a substantial improvement over traditional inspection methods that typically rely on periodic manual inspections performed by workers or specialized vehicles that can disrupt regular train schedules. As such, example techniques and systems described herein provide a more efficient, comprehensive, and non-disruptive approach to railway track inspection and evaluation that can enhance safety and operational efficiency across the network.

In addition, disclosed examples also enable for the aggregation of sensor data and information describing track conditions from multiple railway vehicles equipped with sensors, which can then allow a computing system to determine and distribute real-time updates of the state of the railway track network. The aggregated sensor data may be used to determine trends, predict potential issues, determine optimal operation ranges for portions of railway track during different environment conditions, update railway network maps to reflect the location of track issues, determine and prioritize repairs of railway segments, modify train routes, and perform other useful actions.

To generate sensor data related to track conditions, example systems and techniques may use a variety of sensor configurations, with the type, quantity, positions, and other parameters of the sensors varying based on specific uses and constraints. These differences can offer various benefits and trade-offs in some cases. For instance, sensor types used by an example system may range from simple accelerometers to advanced LiDAR systems. In some cases, basic system setups might rely primarily on accelerometers and GPS to detect track irregularities through vibration analysis while more sophisticated systems may incorporate additional types of sensors, such as cameras and other optical sensors, ground-penetrating radar, and/or ultrasonic sensors for comprehensive track evaluation. As such, the choice of sensors may depend on the desired level of detail in track assessment, the specific issues of concern, the desired cost of the system, and other potential factors. Some example sensors that may be used include microphones, accelerometers, gyroscopes, optical cameras, LiDAR, radar, ultrasonic sensors, eddy current sensors, infrared cameras, lasers, GPS receivers, strain gauges, acoustic emission sensors, magnetic flux leakage sensors, tilt sensors, moisture sensors, temperature sensors, electromagnetic field sensors, pressure sensors, wheel slippage sensors, and chemical sensors, among other options.

The quantity of sensors can vary between example systems. For instance, some systems may use a smaller set of sensors strategically placed on specific components, while other example systems may use a dense array of sensors, which can be positioned on one or multiple railway vehicles within a trainset. A higher number of sensors may provide more detailed and redundant data, potentially improving accuracy and reliability. Increasing the number of sensors, however, may also increase system complexity and cost.

Furthermore, sensor positioning may differ based on desired performance of the sensors within examples. For example, accelerometers may be placed on the axle boxes to provide direct measurements of track-induced vibrations, while other accelerometers may be positioned on the car body to obtain measurements related to overall ride quality. Optical sensors may be mounted at the front of the train and used to provide early detection of visible track defects, while undercarriage-mounted sensors may be used to capture detailed views of the steel rail and railway tie conditions. In some examples, some systems may use fixed sensor positions, while others may have adjustable or movable sensor mounts. Adjustable positions may allow for optimization based on different train configurations or inspection priorities, but may require more complex setup and calibration procedures. The type of mount may depend on the type and desired use of the sensor. In addition, operational parameters used by sensors may also be adjusted, which can eliminate the need to mechanically move some types of sensors once the sensor is initially positioned onto the railway vehicle. For instance, an onboard computing system may adjust operation parameters of various sensors as the railway vehicle travels on railway tracks towards its destination.

In some examples, the sampling rate of the sensors can differ and may be adjustable by a computing system. For instance, higher sampling rates may be used to capture more detailed data about track conditions, particularly for high-frequency vibrations or rapid changes in track geometry. The higher sampling rate may also generate larger volumes of data, which might require more processing power and storage capacity. Thus, the computing system may decrease the sampling rate in some scenarios, such as while the railway vehicle travels a segment of track known to be in good condition. As such, sensor sensitivity, range, and other operational parameters used by some sensors can be tailored to specific inspection goals. For instance, sensitive accelerometers may detect subtle changes in track conditions but may be more prone to noise and false positives. Sensors with wider measurement ranges may be able to capture more extreme events but might sacrifice some precision in normal operating conditions. Some example systems may use specialized sensors for specific environmental conditions. For example, heated sensors may be used in cold climates to prevent ice buildup, while ruggedized sensors may be used in areas with high levels of dust or debris.

The integration of different sensor types can provide complementary data for evaluating track conditions. For instance, combining accelerometer data with optical measurements may allow for correlation between detected vibrations and visible track defects, improving the accuracy of issue identification. Similarly, multiple sensors of the same type may also be used to evaluate track conditions. For instance, multiple cameras can image portions of the track from different angles to provide additional information for the computing system to use to evaluate conditions of the track. In some cases, the computing system may use sensor fusion and other techniques to evaluate track conditions using different types of sensor data.

Some example systems and techniques may use adaptive sensor configurations that may automatically adjust based on operating conditions. For example, the system might increase the sampling rate or activate additional sensors when entering areas known to have track issues, after detecting an initial issue, or during adverse weather conditions. Such sensor configurations may also be able to be manually adjusted based on instructions from an onboard computing system or an operator.

Example systems and techniques may enable the aggregation of data generated during multiple passes over the same track sections by one or more multiple railway vehicles equipped with sensors. Data aggregation can occur locally using memory located onboard each railway vehicle and using remote memory associated with a computing system positioned physically separate from the railway vehicle(s). In some cases, the aggregated data may be stored in time-series databases or data warehouses, allowing for efficient analysis of trends over time.

Machine learning algorithms may be applied to the aggregated data to identify patterns and trends. For example, clustering algorithms may be used to group track sections with similar degradation patterns, while anomaly detection algorithms may be used to flag unusual changes in track conditions. In some cases, an example system may use one or multiple predictive analytics models that use historical data to forecast future track conditions. These models may consider factors such as traffic volume, weather patterns, and maintenance history to predict how track conditions might evolve. In addition, cross-correlation analysis may be performed to identify relationships between different types of track issues or between track conditions and external factors. This may help in understanding the root causes of recurring problems.

Example systems and techniques may generate information for review by train operators, network operators, and maintenance crews, such as visualizations like heat maps, updated network maps, or trend graphs to make the detected trends easily interpretable. These visualizations may highlight areas of gradual degradation or emerging patterns of concern. In addition, automated alerting mechanisms may be implemented by a computing system to flag changes in trends that exceed a threshold. For instance, if a particular track segment shows an accelerating rate of degradation across multiple sensor inputs, the computing system may generate an alert for further investigation or perform other actions. As such, by integrating and analyzing data from multiple sensor types over time, the computing system may provide a comprehensive view of track health, which can enable the detection of subtle, long-term trends that may signal future track issues. This approach may allow for more proactive and efficient maintenance planning.

An example system may detect various track issues such as ballast washout, deteriorating railway ties, missing spikes, broken joints, warped track, and rail pitting. These problems, if left unaddressed, could potentially compromise track integrity and safety. For instance, ballast washout can lead to track instability, while deteriorating rail ties and missing spikes may cause misalignment or gaps in the rails. Warped track and rail pitting indicate stress or wear that could progress to more serious defects. The system may also monitor weather-related hazards, adding another layer of safety and operational efficiency. This includes detecting rainy or icy conditions that reduce traction, fallen leaves that create slippery surfaces, and potential rockslides in mountainous areas. By continuously monitoring these factors, the system can generate real-time alerts for operators, enabling proactive measures such as implementing speed restrictions, dispatching maintenance crews, or halting traffic in extreme cases.

The ability to detect a wide range of issues offers versatility and may reduce reliance on manual inspections. The system provides consistent, objective data on track conditions that can complement human expertise, allowing inspectors to focus on areas flagged as potentially problematic. This approach enables more efficient allocation of maintenance resources and potentially reduces the frequency of manual inspections. The objective data analysis generated by the system's sensors and algorithms provides quantifiable information on track conditions, minimizing the potential for human error or subjective assessments that can vary between inspectors.

Example systems may also integrate with existing train control systems, such as Positive Train Control (PTC), to automatically adjust train operations based on track conditions. This may include enforcing speed restrictions or suggesting alternate routes without requiring direct operator intervention. In some cases, for less urgent information, the system may generate regular reports or bulletins that are distributed to operators and maintenance crews. The reports may provide a comprehensive overview of track conditions across the network, highlighting trends and areas requiring attention.

In some examples, a computing system may perform automated compliance checks against regulatory standards set by bodies such as the Federal Railroad Administration (FRA) or the Association of American Railroads (AAR). This process may involve maintaining an up-to-date database of regulatory requirements and continuously comparing collected track condition data against established thresholds. Parameters monitored may include track geometry measurements, rail wear and profile, track structure components, signal system functionality, and bridge and tunnel conditions. When a parameter exceeds regulatory limits, the computing system may automatically flag the issue, generating alerts, marking the specific location of the non-compliant condition, and categorizing the severity of the violation.

The computing system may then generate automated reports detailing any compliance issues, including the nature of the non-compliance, the specific regulation violated, the location and extent of the issue, and recommended actions. Based on severity, the computing system may prioritize issues for maintenance and repair activities. These automated checks create a digital record of track conditions and compliance status, useful for audits and regulatory inspections. By performing these checks, the computing system can help railway operators maintain their infrastructure within regulatory standards, potentially improving safety and reducing the risk of penalties or operational restrictions due to non-compliance.

In some examples, the system may implement a peer-to-peer communication network among trains. In this setup, trains may directly share track condition information with other nearby trains, providing redundancy and improving the speed of information dissemination. In areas with limited connectivity, the system may utilize a store-and-forward mechanism. Trains passing through these areas may collect and store track condition data, then transmit this information to other trains or central systems once they regain connectivity. The communication system may also include a feedback mechanism, allowing train operators to report or confirm track issues they observe. This human input may be integrated with sensor data to provide a more comprehensive assessment of track conditions. By using various communication methods, the system may ensure that track condition information is quickly and reliably disseminated to all relevant parties, enhancing the safety and efficiency of railway operations.

The following description and accompanying drawings will elucidate features of various example embodiments. The embodiments provided are by way of example, and are not intended to be limiting. As such, the dimensions of the drawings are not necessarily to scale. Example systems and methods within the scope of the present disclosure will now be described in greater detail.

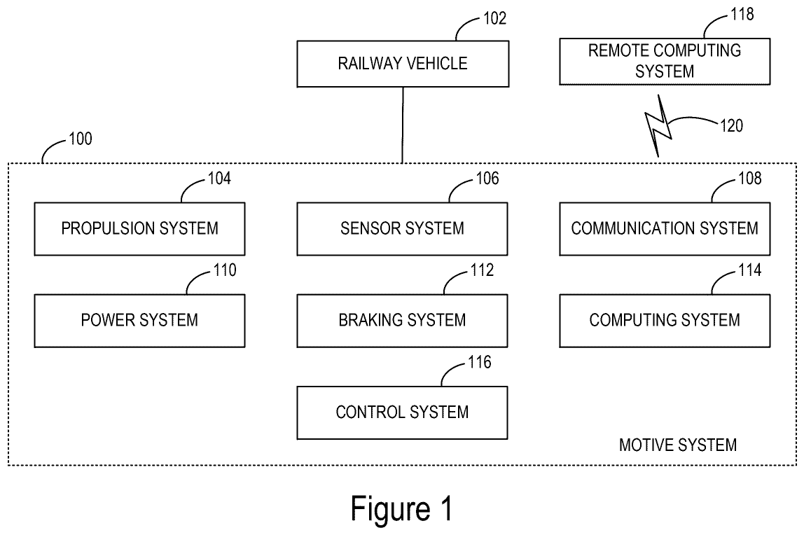

Referring now to the figures, FIG. 1 is a functional block diagram for motive system 100, which can be implemented on railway vehicle 102 and configured to perform disclosed operations. In the example embodiment, motive system 100 may include various subsystems, such as propulsion system 104, sensor system 106, communication system 108, power system 110, braking system 112, computing system 114, and control system 116. In other examples, motive system 100 may include more or fewer subsystems. In addition, the subsystems and other components of motive system 100 can be interconnected via wired or wireless connections and operations performed by motive system 100 can be divided into additional functional or physical components and/or combined into fewer functional or physical components within examples.

Railway vehicle 102 represents any type of vehicle that can transport people and/or cargo on a railway track. This includes, but is not limited to, freight trains, passenger trains, locomotives, trolleys, and other types of railcars. Railway vehicles are typically designed to transport goods, materials, or passengers over long distances and may be capable of self-propelling functions. For instance, railway vehicle 102 may be powered by various types of energy sources, such as diesel, electricity (e.g., electric motor with a battery system), or alternative fuels. In some cases, railway vehicle 102 is a self-propelled railcar equipped with an energy-efficient control system that enables railway vehicle 102 to travel in an autonomous or semi-autonomous mode, which may be part of a trainset or individually.

In some examples, railway vehicle 102 may be a freight car or a flatbed car configured to move materials or other types of materials. For instance, railway vehicle 102 may be a burdened rail vehicle. Traditional locomotives are unburdened (i.e., not carrying payload) whereas traditional freight railcars are unpowered and serve to carry payloads similar to trailers as burdened vehicles. As such, the size, shape, and configuration of railway vehicle 102 can differ within examples. In addition, the number and types of axles and wheels on railway vehicle 102 can vary. Generally, railway vehicle 102 may include two axles per truck with two trucks per railcar. Railway vehicle 102 may also include one or multiple types of couplers that enable railway vehicle 102 to be coupled to other railway vehicles.

Propulsion system 104 of motive system 100 may be designed with a variety of components to provide powered motion for railway vehicle 102. For instance, propulsion system 104 could include one or more motors that utilize power from power system 110 to generate torque, thereby rotating the wheels of railway vehicle 102. In some cases, propulsion system 104 may be designed with different types of motors. For example, propulsion system 104 could use electric motors, hydraulic motors, or pneumatic motors. These different types of motors could provide different benefits, such as improved energy efficiency or increased torque. In addition, propulsion system 104 could use power from different types of power systems. For instance, propulsion system 104 may use power from a battery (or battery system), a fuel cell, a solar panel, and/or a generator. These different types of power systems could provide different benefits, such as improved energy efficiency or increased operational range.

In some examples, propulsion system 104 may generate torque in different ways. For example, propulsion system 104 may use a gearbox to increase the torque or a direct drive system to eliminate the gearbox and reduce mechanical losses. These different methods of torque generation could provide different benefits, such as improved efficiency or reduced maintenance requirements. Similarly, propulsion system 104 may also rotate the wheels of railway vehicle 102 in different ways. For example, propulsion system 104 may use a chain drive, a belt drive, or a direct drive system. These different methods of wheel rotation could provide various benefits, such as improved efficiency or reduced noise.

Furthermore, propulsion system 104 could be configured in different ways. For example, propulsion system 104 may be a centralized system with a single motor driving all the wheels, or it could be a distributed system with individual motors driving each wheel. The different configurations could be selected based on the different benefits that each configuration is designed to provide, such as improved traction or increased redundancy.

Sensor system 106 may include one or multiple sensors that can help enhance the performance of railway vehicle 102. In particular, sensor system 106 may be used to gather and process data about the environment in which railway vehicle 102 operates, the performance of the vehicle's components, and to tailor the performance of railway vehicle 102 to suit its environment. In addition, sensor system 106 may include one or multiple sensors used to generate sensor data that can be used to evaluate the track conditions as well as the condition of related track infrastructure like switches and signs.

In some examples, sensor system 106 may encompass a diverse range of sensors, such as one or more radars, LiDARs, cameras, optical sensors, wind sensors, force sensors, contact sensors, precipitation sensors, light sensors, humidity sensors, strain gauges, pressure transducers, thermal imaging sensors, radio navigation units, encoders, resolvers, laser range finding sensors, Radio-Frequency Identification (RFID) sensors, gyroscopes and magnetometers, accelerometers, magnetic sensors, microphones, strain and weight sensors, GPS receivers, IMUs, passive infrared sensors, ultrasonic sensors, wheel speed sensors, and/or throttle/brake sensors. Within examples, railway vehicle 102 may include one or more of these sensors as well as other types of sensors. In some cases, a wide array of sensors may allow motive system 100 to gather a comprehensive set of data about the operation of railway vehicle 102 and its environment, enhancing the control system's ability to determine a control strategy for operating railway vehicle 102.

Sensor system 106 may also include sensors that are specifically configured to monitor the existing components of railway vehicle 102. This could include sensors that monitor the status and performance metrics of the train's engine, brakes, battery system, and other components. In some cases, sensor system 106 may also use multiple sensors to provide safety redundancy, ensuring that motive system 100 can continue to operate safely even if one sensor fails. This redundancy feature enhances the reliability and safety of the control system of railway vehicle 102, ensuring that it can maintain optimum operation even in the event of sensor failures.

The sensors from sensor system 106 can be strategically placed on different components of railway vehicle 102. For instance, some sensors could be positioned on the couplers of railway vehicle 102, while others may be housed in a specific container positioned near the front or rear end of railway vehicle 102. Some sensors could be designed to measure specific aspects of the couplers on railway vehicle 102. For instance, these sensors could provide data on the stress level on the couplers, which could be used to monitor the structural integrity of the couplers and prevent potential failures. In some examples, sensors are positioned on the wheels or axles to monitor their rotation and detect any irregularities. Sensors may also be placed inside the cargo compartments to monitor the condition of the cargo, such as temperature or humidity sensors for perishable goods. Sensors may be installed in pneumatic braking air hoses/pipes to monitor the pressure levels. A strategic placement of sensors allows sensor system 106 to gather detailed and accurate data about the operations of railway vehicle 102 and its components.

In some examples, sensor system 106 may include sensors that can detect waypoints positioned along the railway track. The waypoints may provide useful information about the location, direction, and speed of railway vehicle 102, which could be used by the control system to adjust the operations of railway vehicle 102 in real-time. Sensor system 106 may also enable railway vehicle 102 to triangulate its position relative to off-board radio stations and other sources of communication signals, such as 4G or 5G towers. This could provide more accurate and real-time data about the location and speed of railway vehicle 102, enhancing the control system's ability to determine the optimum speeds for railway vehicle 102 as conditions change.

Sensor system 106 can also be used to weigh railway vehicle 102 and adjust the performance of the electric motors and other components located on railway vehicle 102. This could involve sensors that measure the weight of railway vehicle 102 and its cargo, which could be used to adjust speed of railway vehicle 102 and power output to maintain optimum energy efficiency and safety. This weight measurement feature can allow the control system to adapt the operation of railway vehicle 102 to its load, ensuring that motive system 100 can maintain optimum energy efficiency and safety even as the weight of railway vehicle 102 shifts or changes.

In some examples, sensor system 106 can be supplemented by additional devices. These devices could include additional sensors, control systems, or communication devices that enhance the performance and functionality of sensor system 106. This flexibility in the design of sensor system 106 allows it to adapt to different operational requirements and environmental conditions, enhancing its performance and functionality.

In some examples, sensor system 106 may include a motor encoder and/or resolver data, which can be used to detect wheel slipping on railway vehicle 102 due to wet, icy, or debris-laden tracks. In response to this detection, computing system 114 may implement effective control strategies to maintain the traction and safety of railway vehicle 102. Onboard sensors within sensor system 106 can also be used to detect potential vandalism. For instance, computing system 114 may use cameras and radar to detect potential vandalism and responsively transmit information to a user and/or authorities to protect the cargo and payloads via communication system 108.

In addition, sensor system 106 can be used for automated track inspections and to determine the condition of the rail. In some cases, computing system 114 may determine deviation from normal rail characteristics based on sensor data from sensor system 106. For instance, computing system 114 may detect railcar hunting, vibration, and other dynamics based on sensor data obtained from sensor system 106. This could provide valuable information about the condition of the track and the train's operation, which may be used by computing system 114 to adjust the train's speed and trajectory to maintain optimum energy efficiency and safety.

In some examples, sensor system 106 may also include different types of sensors beyond those mentioned. For instance, sensor system 106 may include pressure sensors to monitor the air pressure in the pneumatic braking system, vibration sensors to detect abnormal vibrations in the components of railway vehicle 102, or acoustic sensors to detect unusual noises that could indicate a mechanical problem. These additional sensors could provide more comprehensive data about the operations of railway vehicle 102 and its environment, further enhancing the control system's ability to determine the operating speeds for railway vehicle 102.

Sensor system 106 may be integrated with other systems on a train. For example, sensor system 106 may be integrated with communication system 108 to transmit sensor data to a remote control station (e.g., remote computing system 118) or to other trains. Sensor system 106 could also be integrated with power system 110 to draw power for its operation. This integration could enhance the functionality and efficiency of sensor system 106, which allows for more effective and reliable operation.

The sensor data may be processed in different ways to determine control strategy for railway vehicle 102. For example, the data may be processed using machine learning algorithms to learn from past data and make more accurate predictions about speed ranges to use during navigation along portions of track. The speed ranges may depend on weather conditions, type and size of load, and/or other parameters (e.g., length of train). Sensor data may also be processed using statistical methods to analyze the data and identify patterns or trends that could be used to optimize the speed and other control parameters of railway vehicle 102.

In some examples, sensor system 106 may include additional layers of redundancy to ensure its reliability and safety. For example, sensor system 106 may include multiple sensors of the same type, so that if one sensor fails, the others can continue to provide data. Sensor system 106 may also include backup power sources for the sensors, ensuring that they can continue to operate even if the main power source fails. In addition, the sensors within sensor system 106 may be calibrated in different ways to ensure their accuracy and reliability. For example, sensors may be calibrated using standard calibration techniques, or they could be self-calibrating, adjusting their calibration based on the data they collect. This could enhance the accuracy and reliability of the sensor data, further improving the control system's ability to determine the optimum speeds for the train.

As further shown in FIG. 1, motive system 100 may include communication system 108, which may be used to communicate with one or more devices (e.g., remote computing system 118) directly or via a communication network (e.g., wireless connection 120). In some examples, communication system 108 may include one or multiple dedicated short-range communications (DSRC) devices that could include public and/or private data communications with stations positioned near tracks.

In general, communication system 108 may facilitate the exchange of information with other devices and between components of railway vehicle 102. The exchange of information could include communication with remote computing system 118, which might be a centralized server or control station that oversees the operation of multiple trains. The communication between the control system of railway vehicle 102 and remote computing system 118 may be facilitated through a communication network, such as a wireless connection 120. This may involve using standard wireless communication protocols, such as Wi-Fi or cellular networks, or it could involve using specialized communication protocols designed for railway operations.

In some embodiments, communication system 108 may include one or more dedicated short-range communications (DSRC) devices. These devices are designed to provide reliable, high-speed wireless communication over short distances, making them ideal for communication with stations positioned near the tracks. The DSRC devices could support both public and private data communications, allowing them to exchange information with a wide range of devices and systems. For example, DSRC devices may be used to communicate with sensors or control systems located at railway stations, crossings, or other points of interest along the tracks.

In addition to DSRC devices, communication system 108 may also include other types of communication devices or technologies. For instance, communication system 108 may include long-range communication devices for communicating with remote control stations or other trains over longer distances. Communication system 108 may also include satellite communication devices for global positioning or communication with satellite-based systems. Furthermore, communication system 108 may also include wired communication devices (e.g., Ethernet, cables) for connecting with onboard systems or devices, such as control system 116, computing system 114, and sensor system 106.

Communication system 108 may also be designed to support different types of data communications. For example, communication system 108 may support real-time data communication for immediate control or monitoring purposes. Communication system 108 may also support batch data communication for transmitting larger amounts of data at scheduled intervals. Moreover, communication system 108 may support secure data communication for transmitting sensitive or confidential information, such as operational data or safety information.

Power system 110 represents one or multiple power sources that can supply power to different components of motive system 100 and/or railway vehicle 102. In some cases, power system 110 may be shared across multiple railway vehicles within a train set. For instance, direct electrical connections can exist between power systems on different railway vehicles within a train. In addition, multiple power systems may be used to share energy in different ways, such as using an overcharged battery pack to kinetically recharge a depleted or lower state of charge battery pack. Batteries can be recharged during operation of railway vehicle 102, such as through regenerative braking, or they can be replaced or recharged during stops. In addition to batteries, power system 110 may also use petroleum-based fuels or gas-based fuels. These energy sources can provide a high amount of energy, making them suitable for long-distance travel or heavy-duty operations. Alternatively, the power system 110 could use solar panels or other types of renewable energy sources. These sources can provide a sustainable and environmentally-friendly source of power, although their output can be variable and dependent on environmental conditions.

In some embodiments, the power system 110 may include a combination of different power sources. For example, it could include a combination of batteries, capacitors, and/or flywheels. This hybrid approach can provide the benefits of multiple power sources, such as the high energy density of batteries, the rapid charge and discharge capabilities of capacitors, and the mechanical energy storage of flywheels.

Braking system 112 may represent one or multiple supplementary brake systems that motive system 100 may include to further enhance performance of railway vehicle 102. The primary braking system can be pneumatic, with brake airlines pressurized from compressors on board the locomotive, and used in conjunction with braking system 112. For instance, braking system 112 may be a regenerative brake system that can serve as an energy recovery mechanism that also slows down the railway vehicle by converting its kinetic energy into a form that can be used immediately or stored. For instance, braking system 112 may convert kinetic energy into energy stored by one or more batteries of power system 110. In some instances, braking system 112 can dissipate the energy as heat, such as when the battery storage on railway vehicle 102 is full. This heat dissipation can help prevent overheating of the batteries and prolong their lifespan.

In some embodiments, braking system 112 can be a regenerative braking system that can be used to feed electricity directly into the electrical grid through overhead catenary lines or other technologies (e.g., third rails used for power). Braking system 112 may also be used during short sections of track without requiring full electrification of the track lines to take advantage of traditional un-electrified rail as well as short electrified sections for recharging and returning power to the grid.

Computing system 114 represents one or multiple computing devices that can perform operations, such as the various operations described herein. Computing system 114 may include one or multiple processors that can execute instructions stored in a non-transitory computer readable medium (e.g., data storage). The instructions can enable computing system 114 to operate with the various subsystems of motive system 100 and other computing devices (e.g., remote computing system 118).

In some examples, motive system 100 may use communication system 108 to facilitate the exchange of data and control signals with remote computing system 118. This communication may be facilitated over wireless connection 120, which may involve standard wireless communication protocols, such as Wi-Fi or cellular networks, or it could involve specialized communication protocols designed for railway operations.

In addition to its computational and communication capabilities, computing system 114 may also include one or multiple user interface elements. These elements enable users to interact with the system, providing instructions and receiving information from the motive system 100. For instance, computing system 114 may include one or more input/output devices, such as a tablet touchscreen or industrial hand-controller for intuitive control and data input, a speaker for auditory feedback or alerts, and a microphone for voice commands or communication.

In some embodiments, computing system 114 is designed with a focus on reliability and resilience. For instance, computing system 114 may be designed to be self-redundant, offering duplex or triplex redundancy in case of a partial system failure. This design allows computing system 114 to continue operations safely in the event of a failure, ensuring that railway vehicle 102 can maintain its mission, operation, and safety. Furthermore, the redundant system can also serve as a verification and validation mechanism for the sensor inputs received from sensor system 106. This can enhance the accuracy and reliability of the data used by the system, further improving its performance and safety.

Control system 116 can include one or multiple components designed to assist in the operations of railway vehicle 102. For instance, control system 116 can include components that enable control of other components of motive system 100 and/or a proportional-integral-derivative controller (PID controller or three-term controller) that is a control loop mechanism employing feedback that is widely used in industrial control systems and a variety of other applications requiring continuously modulated control. In some examples, remote computing system 118 may communicate control instructions to control system 116, which can then execute a control strategy based on the control instructions.

Remote computing system 118 represents a computing system that may provide information and/or control instructions to motive system 100 and/or railway vehicle 102. For instance, remote computing system 118 may be a smartphone, server, laptop, tablet, wearable computing device, industrial hand-controller and/or another type of device that enables inputs to different components within motive system 100. Remote computing system 118 may provide a user interface that enables remote control of railway vehicle 102. In some examples, remote computing system 118 may be a network of computing systems that can perform operations described herein.

Motive system 100 may include other pneumatic elements for auxiliary services, such as dump, gate, hatch, or door actuation. These systems can be actuated via solenoids remotely or manually. Gate, hatch, or door actuation can be supplied from the same compressors or completely separate air systems from the brake air infrastructure.

In addition, motive system 100 can also include additional systems, such as a cooling system that can service other systems. For instance, the cooling system can cool onboard battery storage, electric motors, inverters using liquid or air cooled subsystems in order to keep the components in satisfactory operating temperatures. The cooling system can also be used to cool the compressors and air drying/treating equipment for the pneumatic systems. This can help to maintain the efficiency and reliability of these systems, as well as prolong their lifespan.

The cooling systems could be interconnected in various ways to optimize their performance and efficiency. For example, they could be linked in a single loop, allowing the coolant to flow through all the systems in a continuous cycle. Alternatively, they could be arranged in series or parallel configurations, depending on the thermal loads and cooling requirements of the different systems. In some cases, each system may have its own dedicated subsystem for cooling. This can provide more precise control over the cooling of each system and can be beneficial in situations where the systems have different cooling requirements or operating conditions.

In other cases, a combination of a master cooling system and additional cooling subsystems can be used. The master cooling system could provide the primary cooling for the major components of motive system 100, while the additional cooling subsystems could provide supplementary cooling for specific components or systems. This hybrid approach can provide a balance between efficiency and flexibility, allowing the cooling system to adapt to a wide range of operational scenarios and environmental conditions.

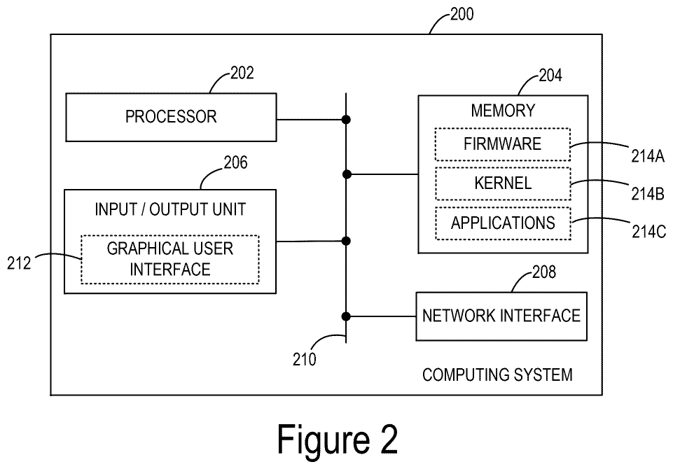

FIG. 2 is a block diagram of computing system 200, illustrating some of the components that could be included in a computing device arranged to operate in accordance with the embodiments herein. As such, computing system 200 may be implemented as computing system 114 of motive system 100 and/or remote computing system 118 shown in FIG. 1. In some examples, computing system 200 may communicate with one or more accessories attached to a railway vehicle via one or more bearing adapters.

In the example embodiment shown in FIG. 2, computing system 200 includes processor 202, memory 204, input/output unit 206, and network interface 208, all of which may be connected by a system bus 210 or a similar mechanism. In some example embodiments, computing system 200 may include other components and/or peripheral devices (e.g., detachable storage and/or sensors).

Processor 202 may be one or more of any type of computer processing element, such as a central processing unit (CPU), a co-processor (e.g., a graphics processor), a digital signal processor (DSP), a network processor, and/or a form of integrated circuit (e.g., a field programmable gate array (FPGA)) or controller that performs processor operations. As such, processor 202 may be one or more single-core processors and/or one or more multi-core processors with multiple independent processing units. In addition, processor 202 may also include register memory for temporarily storing instructions being executed and related data, as well as cache memory for temporarily storing recently-used instructions and data.

Memory 204 may be any form of computer-usable memory, including but not limited to random access memory (RAM), read-only memory (ROM), and non-volatile memory. This may include flash memory, hard disk drives, solid state drives, rewritable compact discs (CDs), rewritable digital video discs (DVDs), and/or tape storage, as just a few examples. Computing system 200 may include fixed memory as well as one or more removable memory units, the latter including but not limited to various types of secure digital (SD) cards. As an example result, memory 204 can represent both main memory units as well as long-term storage.

Memory 204 may store program instructions and/or data on which program instructions may operate. By way of example, memory 204 may store these program instructions on a non-transitory, computer-readable medium, such that the instructions are executable by processor 202 to perform any of the methods, processes, or operations disclosed in this specification or the accompanying drawings.

As shown in FIG. 2, memory 204 may include firmware 214A, kernel 214B, and/or applications 214C. Firmware 214A may be program code used to boot or otherwise initiate some or all of computing system 200. Kernel 214B may be an operating system, including modules for memory management, scheduling and management of processes, input/output, and communication. In addition, kernel 214B may also include device drivers that allow the operating system to communicate with the hardware modules (e.g., memory units, networking interfaces, ports, and busses) of computing system 200. Applications 214C may be one or more user-space software programs, such as web browsers or email clients, as well as any software libraries used by these programs. In some examples, applications 214C may include one or more control systems 116, neural network applications and other deep learning-based applications. Memory 204 may also store data used by these and other programs and applications.

Input/output unit 206 may facilitate user and peripheral device interaction with computing system 200, sensors, and/or other computing systems, such as computing systems on other railway vehicles and/or positioned remote from a train. Input/output unit 206 may include one or more types of input devices, such as a keyboard, a mouse, one or more touch screens, sensors, biometric sensors, and so on. Similarly, input/output unit 206 may include one or more types of output devices, such as a screen, monitor, printer, speakers, and/or one or more light emitting diodes (LEDs). Additionally or alternatively, computing system 200 may communicate with other devices using a universal serial bus (USB) or high-definition multimedia interface (HDMI) port interface, for example. In some examples, input/output unit 206 can be configured to receive data from other devices. For instance, input/output unit 206 may receive sensor data from sensors, such as sensors positioned on a railway vehicle.

As shown in FIG. 2, input/output unit 206 includes Graphical User Interface (GUI) 212, which can be configured to provide information to a user. GUI 212 may involve one or more display interfaces, or another type of mechanism for conveying information and receiving inputs. Some common rail techniques can involve signal lighting, horns, and bells, which can be implemented via input/output unit 206. With many techniques in traditional rail being visual and auditory in nature, these techniques in addition to more advanced signaling and human machine interfaces can be implemented. In some examples, GUI 212 is used to convey information related to railway vehicle performance, route instructions, track conditions, weather conditions, and other useful information.

Network interface 208 may take the form of one or more wireline interfaces (e.g., Ethernet) and/or enable communication over one or more wireless interfaces, such as IEEE 802.11 (Wi-Fi), BLUETOOTH®, private wireless network (using the Citizens Broadband Radio Service (CBRS)), global positioning system (GPS), 3G, 4G, 5G, or a wide-area wireless interface. In addition, other forms of physical layer interfaces and other types of standard or proprietary communication protocols may be used over network interface 208.

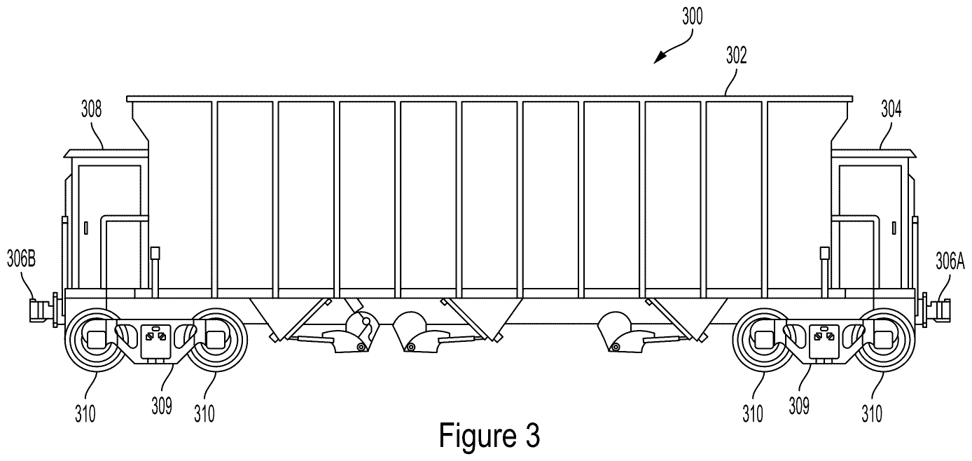

FIG. 3 illustrates a configuration of railway vehicle 302 equipped with motive system 300. In the example embodiment, motive system 300 is implemented on railway vehicle 302 and includes sensor system 304 positioned near front coupler 306A and battery storage 308 located near rear coupler 306B. Railway vehicle 302 may be controlled according to a route and a control strategy determined by a computing system performing techniques presented herein.

In the example embodiment, railway vehicle 302 is shown as a freight vehicle designed to carry materials and other cargo between locations. Railway vehicle 302 has front side 312 and rear side 314, which can each be attached to different railway vehicles within a trainset/consist via front coupler 306A and rear coupler 306, respectively. As shown, railway vehicle 302 includes bogies 309 (or trucks) that enable movement on wheels 310. As such, motive system 300 can involve installation of one or multiple components (e.g., electric motors, braking systems) on bogies 309 via one or more bearing adapters and other components of railway vehicle 302. Railway vehicle 302 can have alternative configurations within other embodiments. In addition, railway vehicle 302 can be part of a train that includes one or multiple railway vehicles equipped with motive systems 300.

Motive system 300 can be implemented as motive system 100 shown in FIG. 1 and can include one or more electric drive systems and an auxiliary braking system that can enable motive system 300 to perform operations disclosed herein that can enhance overall performance of railway vehicle 302. For instance, motive system 300 may include one or multiple electric drivetrains that can be used to turn axles connected to wheels 310. In addition, motive system 300 may also include a regenerative braking system that can be used to convert energy from one or more axles and/or wheels 310 and deliver energy to battery storage 308 during braking applications.

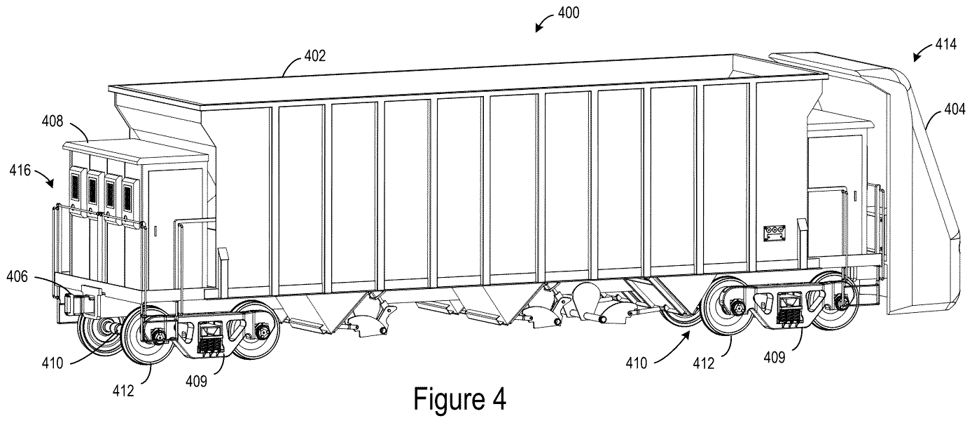

FIG. 4 illustrates another configuration of railway vehicle 402 configured with motive system 400, which can similarly include components of motive system 100 shown in FIG. 1 and may enable railway vehicle 402 to operate autonomously and without locomotives.

Railway vehicle 402 is similar to railway vehicle 302 shown in FIG. 3, but differs at the front end of railway vehicle 402. In particular, motive system 400 implemented on railway vehicle 402 includes sensor component 404 that may include additional sensors (e.g., cameras, radar) to enable railway vehicle 402 to perform operations typically completed by a locomotive. Railway vehicle 402 includes coupler 406 and bogies 409 configured with axles 410 and wheels 412 as shown in FIG. 4. As such, bogies 409 and disclosed bearing adapters can be used to position motors and/or other components that enable railway vehicle 402 to be self-propelled. In some examples, regenerative braking components can be attached to axles 410, bogies 409, and/or wheels 412. In addition, housing 408 may include batteries and/or other components for motive system 400. Railway vehicle 402 has front “A” side 414 and rear “B” side 416 as shown in FIG. 4. Rear side 416 can be coupled to another railway vehicle within a train set via coupler 406.

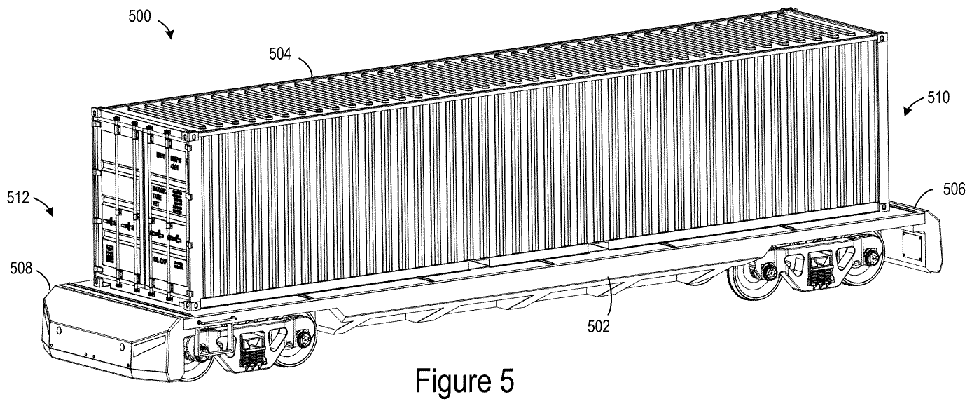

FIG. 5 illustrates an additional configuration of railway vehicle 502 configured with motive system 500, which can similarly include components of motive system 100 shown in FIG. 1 and may enable railway vehicle 502 to operate autonomously and without locomotives. Similar to the examples shown in FIG. 3 and FIG. 4, motive system 500 can include components that can enhance performance of railway vehicle 502.

In the example embodiment, railway vehicle 502 has a flat design to enable one or multiple containers (e.g., shipping container 504) to be positioned on top. Motive system 500 implemented on railway vehicle 502 includes front component 506 positioned at front “A” side 510 and rear component 508 positioned at rear “B” side 512. One or both of front component 506 and rear component 508 can include various components of motive system 500, such as sensors, energy storage (e.g., batteries), etc. In addition, the bogies of railway vehicle 502 can similarly include components of motive system 500, such as regenerative brakes, motors, etc. Motive system 500 can also be designed for standard coupling interfaces and may use one or multiple bearing adapters disclosed herein.

In addition, each railway vehicle 302, 402, 502 can further include additional components, such as emergency brakes, lights, bells, and horns.

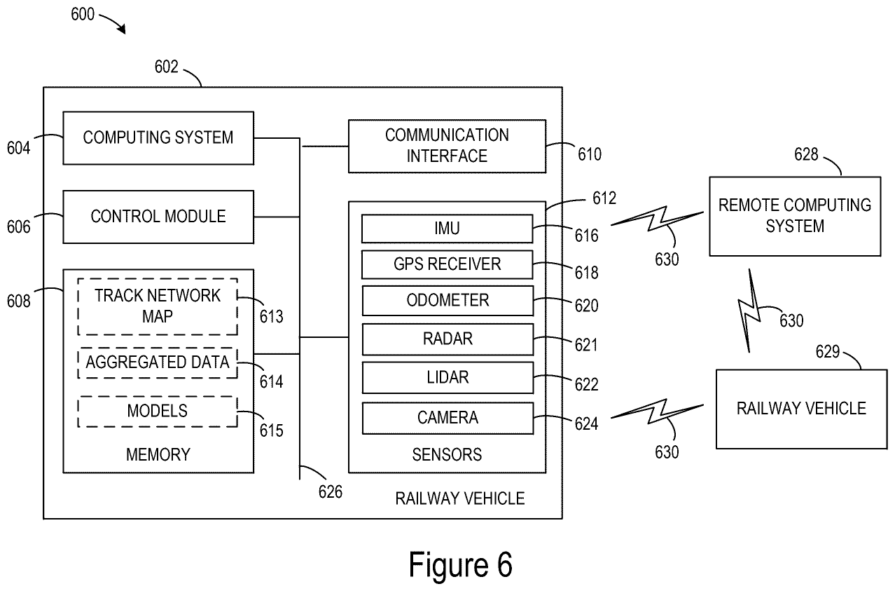

FIG. 6 illustrates a block diagram for automatic track evaluation system 600. In the example embodiment shown in FIG. 6, system 600 includes railway vehicle 602 having wireless connections established with remote computing system 628 and railway vehicle 629. Railway vehicle 602 may include various components like computing system 604, control module 606, memory 608, communication interface 610, and sensors 612 shown in FIG. 6. Memory 608 is shown storing track network map 613, aggregated data 614, and models 615, among other data. In the example embodiment, sensors 612 positioned on railway vehicle 602 include IMU 616, GPS receiver 618, odometer 620, radar 621, LiDAR 622, and camera 624, among other options. Communication interface 610 may be used by railway vehicle 602 to communicate with remote computing system 628 and railway vehicle 629, among other entities. In some examples, system 600 may include additional components, such as other railway vehicles, different sensor configurations, locomotives, and remote computing systems.

Railway vehicle 602 represents various types of vehicles capable of traveling on tracks. In some cases, railway vehicle 602 is a freight car that is retrofitted with sensors 612, computing system 604, communication interface 610, motors, and power sources, among other potential components. These components may be connected via interface connection mechanisms 626, which can represent various types of wired and/or wireless connections. In some cases, railway vehicle 602 may include additional components not shown in FIG. 6.

Computing system 604 represents one or more computing devices configured to perform automatic track inspection and evaluation operations presented herein. The quantity, configuration, type, and position of the computing devices can vary within examples. For instance, computing system 604 may operate as part of control module 606 in some examples. In some cases, computing system 604 may represent a combination of onboard and remote processing devices.

In the example embodiment, computing system 604 is shown linked to control module 606, which may manage one or multiple operations of railway vehicle 602 based on processed sensor data. For instance, computing system 604 may generate control instructions that are executed by control module 606 to control the speed and other operations of railway vehicle 602. As such, computing system 604 may communicate with sensors 612 and control module 606 via wired or wireless connections represented by interface connection mechanisms 626 to perform operations, such as receiving sensor data related to track conditions of a railway track from one or more sensors 612 coupled to railway vehicle 602 as railway vehicle 602 travels on the railway track, using the sensor data to detect one or more track issues associated with the railway track, and transmitting information conveying the one or more track issues associated with the railway track to remote computing system 628. Computing system 604 may adjust sensor operations, railway vehicle operations, power consumption, communicate information to other computing systems, provide alerts using graphical user interfaces and/or other interface technologies (e.g., tactile and audio alerts), among other operations.

Control module 606 may receive processed sensor data indicating current track conditions and other information from computing system 604. Based on this information, control module 606 may dynamically adjust various operational parameters of railway vehicle 602. In some cases, such as scenarios where sensors detect track irregularities or defects, control module 606 may automatically reduce the speed of railway vehicle 602. For example, if severe rail corrugation is detected, control module 606 may limit speed to minimize vibration and potential damage. In some cases, control module 606 may adjust the suspension system of railway vehicle 602 in response to detected track conditions. For instance, if approaching a section with known geometry issues, control module 606 may stiffen or soften the suspension to optimize ride quality and minimize wear. Control module 606 may receive control instructions or other information from computing system 604 in some examples. In addition, computing system 604 and control module 606 may be part of the same computing system in some configurations.

In some examples, when sensors 612 indicate poor adhesion conditions, such as wet or leaf-contaminated rails, control module 606 may modify traction control parameters used by railway vehicle 602. This may involve adjusting wheel slip thresholds, automated application of sand, or altering power application to maintain traction above a threshold level. In curves, control module 606 may use track geometry data to optimize tilting mechanisms (if equipped) for passenger comfort and to reduce lateral forces on the track.

Control module 606 may adjust braking strategies based on track conditions. For example, on steep gradients or in areas with known adhesion issues, control module 606 may implement more conservative braking profiles. If severe track defects are detected that pose immediate safety risks, control module 606 may initiate emergency braking procedures or alert the operator to stop railway vehicle 602. Control module 606 may modify the route or schedule used by railway vehicle 602 in response to detected track conditions. This could involve rerouting to avoid problematic track sections or adjusting arrival times to account for speed reductions.

In electrified systems, control module 606 may adjust power consumption based on the condition of the overhead catenary system, optimizing current collection and minimizing wear on both railway vehicle 602 and infrastructure. Control module 606 may implement predictive control strategies, using data on upcoming track conditions to optimize vehicle performance. For instance, control module 606 may adjust power application in anticipation of grade changes or curves. By integrating track condition data into its control strategies, control module 606 may enhance safety, improve ride quality, optimize energy efficiency, and reduce wear on both railway vehicle 602 and track infrastructure.

As shown, railway vehicle 602 may include memory 608, which can be any form of computer-usable memory, including RAM, ROM, and non-volatile memory. Memory 608 may store program instructions and other data, like track network map 613, aggregated data 614, and models 615. Memory 608 can also represent memory that is distributed across multiple railway vehicles and/or multiple computing devices. For instance, memory 608 may include sub memory located at remote computing system 628. As such, communication interface 610 may be used for data exchange with external systems, including remote computing system 628 and railway vehicle 629.

Sensors 612 represents various types of sensors that railway vehicle 602 may include. In the example embodiment, sensors 612 include IMU 616, GPS receiver 618, odometer 620, radar 621, LiDAR 622, and camera 624. Sensors 612 may also have different configurations within examples, which may include other types of sensors. Sensors 612 can be used to gather various types of data continuously or intermittently as railway vehicle 602 moves along a track (or as railway vehicle 602 is stopped at a particular location). The sampling rate used by some sensors may be adjusted based on factors like railway vehicle speed, track complexity, and/or environmental conditions. Sensor data generated by sensors 612 may be transmitted to computing system 604 for processing. This transmission can occur wirelessly or via wired connections, depending on the specific implementation of the interface connection mechanisms 626.

In addition, wired and wireless sensors may be used within examples depending on the desired design and flexibility of system 600. For instance, wired sensors may be used in some cases to offer more reliable data transmission while wireless sensors may be used to provide greater flexibility in positioning.

Computing system 604 may use track network map 613, aggregated data 614, and/or models 615 stored in memory 608 to evaluate track conditions. For example, computing system 604 may use track network map 613 as a reference to correlate sensor data with specific track locations. Computing system 604 may compare real-time measurements generated by sensors 612 against known track geometry and features to identify deviations or anomalies. As such, track network map 613 may contain information about track curvature, gradients, and other permanent features, allowing computing system 604 to contextualize sensor readings and distinguish between normal track characteristics and potential issues. In some cases, track network map 613 may include historical information about known problem areas or recently maintained sections, enabling more informed analysis of current conditions.

Aggregated data 614 may represent historical data, which can serve as a baseline for comparison that allows computing system 604 to detect gradual changes or deterioration in track conditions over time. Computing system 604 may use aggregated data to establish normal operating ranges for various sensor readings on different track segments, facilitating the detection of outliers or anomalous conditions. Trend analysis of aggregated data 614 may help in predicting future track degradation and identifying sections that may require maintenance in the near future. In some examples, aggregated data 614 may be stored at remote computing system 628.

Models 615 represent machine learning models stored in memory 608, which may be used to classify track defects based on sensor data. Models 615 may be trained on large datasets of known track issues and can quickly identify potential problems. In some cases, predictive models may be used that can forecast future track conditions based on current sensor readings and historical data, enabling proactive maintenance planning. Similarly, physics-based models of vehicle-track interaction may be used to simulate expected sensor readings under various conditions, allowing for more accurate interpretation of actual sensor data. Statistical models may also be used to help in assessing the reliability of sensor readings and determining confidence levels for detected track issues.

In some examples, computing system 604 may integrate track network map 613, aggregated data 614, and models 615 into a track condition evaluation process. For instance, computing system 604 may initially reference track network map 613 to determine the expected characteristics of the current track section. Real-time sensor data may then be compared against both the map information and historical aggregated data 614 for that section to identify any deviations. Computing system 604 may also apply one or multiple models 615 to interpret the sensor data, classify any detected issues, and predict potential future problems. Results from different models and data sources may be combined to provide a comprehensive evaluation of track conditions, potentially assigning confidence levels to detected issues. Computing system 604 may use this integrated analysis to generate alerts, recommend maintenance actions, and/or adjust vehicle operations with assistance from control module 606. By leveraging these resources, computing system 604 can perform context-aware evaluations of track conditions, enhancing the overall effectiveness of system 600.

In some examples, computing system 604 may use the different sensors to evaluate track conditions in real-time as railway vehicle 602 is traveling. For instance, IMU 616 may provide data on acceleration and angular velocity, which may be analyzed by computing system 604 to detect track irregularities, such as misalignments, cross-level issues, or excessive vibrations. Sudden spikes or unusual patterns in IMU data may indicate potential track defects.

Computing system 604 may leverage GPS data from GPS receiver 618 for precise location information, which can be used to correlate sensor readings with specific track locations. This may enable accurate mapping of detected issues as railway vehicle 602 travels on the railway track. GPS data may also be used to verify train speed and position along the track. In some cases, odometer readings from odometer 620 may offer a redundant method for measuring distance traveled and speed of railway vehicle 602. Computing system 604 may use this data to cross-reference with GPS data for more accurate positioning, especially in areas with poor GPS reception.

In some examples, computing system 604 may use radar data from radar 621 to evaluate track conditions. For instance, ground-penetrating radar may be used to assess subsurface conditions. Computing system 604 may analyze radar data to detect issues such as ballast fouling, water accumulation, or subgrade problems that are not visible from the surface. Similarly, LiDAR 622 may be used to provide detailed 3D scans of the track and surrounding environment. Computing system 604 may use LiDAR data to measure track geometry, detect obstructions, assess vegetation encroachment, and identify visible track defects. In addition, computing system 604 may use image data from camera 624, which can represent one or multiple cameras positioned on railway vehicle 602. For instance, optical cameras may capture visual information about the track and its surroundings. Computing system 604 may apply computer vision algorithms to detect visible defects like missing fasteners, rail surface defects, ballast washouts, or damaged ties.

In some examples, computing system 604 may perform sensor fusion to combine data from multiple sensors, which can provide a more comprehensive evaluation of track conditions. For instance, IMU and GPS data may be correlated to precisely locate areas of excessive vibration or movement. Similarly, LiDAR and camera data may be combined to create detailed, annotated 3D models of the track, allowing for both geometric measurements and visual inspection. In addition, radar data may be integrated with surface observations from LiDAR and/or cameras to provide a complete picture of track condition, both above and below the surface. In some cases, IMU data may be used to trigger targeted analysis of camera and LiDAR data, focusing detailed inspection on areas where potential issues are detected. Further, GPS and odometer data may be combined for robust positioning, ensuring accurate location tagging of detected issues even in areas with poor GPS coverage.

In some examples, as railway vehicle 602 travels, computing system 604 may continuously process incoming sensor data, applying filters and preliminary analysis to detect potential anomalies. Computing system 604 may then compare real-time measurements against known track geometry from stored maps and historical data and/or use machine learning models to classify detected anomalies and assess their severity. In some instances, computing system 604 may generate immediate alerts for issues that may require immediate attention. In addition, computing system 604 may accumulate data over time to detect gradual changes or developing issues in track condition. In addition, computing system 604 may also adjust analysis parameters based on current speed, track section, and environmental conditions. By integrating data from sensors 612, computing system 604 may provide a comprehensive, real-time evaluation of track conditions, enabling prompt detection of issues and supporting both immediate safety measures and long-term maintenance planning.

As further shown, railway vehicle 602 may communicate with remote computing system 628 via communication links 630. Remote computing system 628 represents one or multiple computing systems positioned remote from railway vehicle 602, which may include obtaining information and sensor data from computing system 604 to evaluate track conditions and perform various related tasks. Transmissions between railway vehicle 602 and remote computing system 628 may occur in real-time and/or in batches, depending on connectivity and data priority. For example, some issues may be sent immediately by computing system 604 using communication interface 610, while less urgent data may be transmitted when the railway vehicle 602 is in areas with strong network coverage. Remote computing system 628 may receive and store the transmitted data in a centralized database. This data may include processed sensor readings, detected track issues, GPS coordinates, timestamps, and/or any alerts or notifications generated by computing system 604.

In some examples, remote computing system 628 may analyze the received data to evaluate track conditions across the network. For instance, remote computing system 628 may aggregate data from multiple railway vehicles to get a comprehensive view of track health. The aggregated data can be used for comparing new data with historical records to identify trends or progressive degradation. In some cases, remote computing system 628 may use advanced analytics and machine learning models to detect patterns or anomalies that may not be apparent from a single vehicle's data.

In addition, remote computing system 628 may also update and distribute track network maps representing conditions of the tracks. For instance, remote computing system 628 may use received data to update digital track network maps with newly detected issues or changes in track conditions. Remote computing system 628 may also revise information about track geometry, speed restrictions, or maintenance tasks and may also create heat maps or other visualizations to represent track condition across the network.

Remote computing system 628 may distribute updated information to other railway vehicles (e.g., railway vehicle 629) and relevant parties, which may include sending real-time alerts about issues to trains approaching affected track sections. Remote computing system 628 may also provide information that can update onboard systems of all connected railway vehicles with revised track condition data and any new speed restrictions. For instance, remote computing system 628 may also distribute updated models to railway vehicles. In some cases, remote computing system 628 may provide maintenance crews with detailed reports and locations of areas requiring attention. In some cases, to address identified track issues, remote computing system 628 may prioritize maintenance tasks based on issue severity and potential impact on operations, which may also involve generating work orders for maintenance crews. An example work order may include detailed information about the location and nature of each issue. This way, remote computing system 628 may schedule maintenance activities to minimize disruption to railway operations and may also track the progress of repair work and update network-wide information once issues are resolved.

Remote computing system 628 may also use accumulated data for predictive maintenance techniques. For instance, remote computing system 628 may use aggregated data to develop predictive models for track degradation. This may involve identifying patterns that may indicate impending failures or maintenance needs and optimizing maintenance schedules to address issues before they increase in severity. Remote computing system 628 may also perform actions to optimize system 600. For instance, remote computing system 628 may use collected data to refine algorithms and models (e.g., models 615) used for track condition evaluation and improve the accuracy of issue detection and classification. In some cases, remote computing system 628 may also determine sensor configurations or data collection strategies for future implementations based on collected sensor data and corresponding analysis.

In some examples, remote computing system 628 may perform cross-reference and validation techniques. As an example, remote computing system 628 may cross-reference data from multiple railway vehicles passing over the same track sections to validate detected issues. In some cases, remote computing system 628 may compare sensor data with results from manual inspections or specialized inspection vehicles to ensure accuracy. In addition, remote computing system 628 may also generate reports demonstrating compliance with track inspection and maintenance regulations and provide auditable records of track conditions and maintenance activities. By performing these functions, remote computing system 628 can leverage the data collected by individual railway vehicles to maintain a comprehensive, up-to-date understanding of track conditions across the network, enabling more efficient operations, maintenance, and safety management.

Railway vehicle 629 represents one or multiple railway vehicles that may communicate with railway vehicle 602 and/or remote computing system 628. For instance, railway vehicle 629 may communicate information directly or indirectly with computing system 604 on railway vehicle 602. When railway vehicle 629 is part of the same trainset as railway vehicle 602, computing system 604 may transmit data directly to systems on railway vehicle 629 through a train-wide network, such as a wired train-line or short-range wireless connection. This may allow for real-time sharing of track condition information detected by the lead vehicle. If the trainset has a centralized control system, computing system 604 may feed information into this shared system, which railway vehicle 629 can then access. This may include immediate alerts about detected track issues or updated speed recommendations. In some cases, sensor readings from railway vehicle 602 may be relayed through the trainset, allowing railway vehicle 629 to augment its own sensor data with information from the lead vehicle. This may provide a more comprehensive view of track conditions. In some instances, computing system 604 may initiate coordinated actions across the trainset based on detected track conditions. For example, computing system 604 may trigger synchronized braking or suspension adjustments that affect railway vehicle 629.

When railway vehicle 629 is physically separate and potentially traveling on other tracks, computing system 604 may transmit track condition data to remote computing system 628, which then relays relevant information to railway vehicle 629. This may include updates to digital track maps or alerts about issues on shared route sections. For some issues, computing system 604 may initiate broadcast alerts through a wide-area network, which railway vehicle 629 can receive if it's in the affected area or approaching the problematic track section. In areas with limited infrastructure, railway vehicles may form ad-hoc networks to share information. Railway vehicle 629 might receive data from railway vehicle 602 through a series of intermediate vehicles, even if they are not in direct communication range.

In some examples, if railway vehicle 629 later travels on the same track section previously inspected by railway vehicle 602, railway vehicle 629 may receive relevant historical data about track conditions when it connects to a network or enters a station. Based on the route of railway vehicle 629, remote computing system 628 may proactively send it relevant track condition data collected earlier by railway vehicle 602, allowing for route optimization or preparation for known track issues. In some instances, even if operating on different tracks, railway vehicle 629 may receive general alerts or notices derived from data collected by railway vehicle 602, such as weather-related warnings or system-wide maintenance advisories. In addition, when railway vehicle 629 establishes a connection with the central system (e.g., remote computing system 628), railway vehicle 629 may receive a queue of updates that includes relevant information originally sourced from inspections performed by railway vehicle 602. By using these methods, system 600 can ensure that track condition information is disseminated efficiently across the railway network, enhancing safety and operational efficiency for all vehicles, regardless of their physical proximity to the original data source.

In some examples, railway vehicle 602 is a freight railway vehicle with sensors retrofitted onto different existing components via mechanical connections. The retrofitting process may involve attaching the sensors to exterior and/or interior locations on the freight railway vehicle using various types of mechanical connections, such as screws, bolts, clamps, welds, or adhesive mounts. The specific type of mechanical connection used may depend on the type of sensor, the material of the railway vehicle, and other factors. For example, GPS receiver 618 may be mounted on the roof of railway vehicle 602 to capture a clear view of the sky, while IMU 616 and odometer 620 may be mounted near the wheels or axles to accurately measure the motion of railway vehicle 602. Similarly, the freight railway vehicle may include one or more electric motors that can obtain power stored by onboard battery systems. The electric motors can be positioned near an axle or an end cap of the axle to enable the electric motor to rotate the axle and connected wheels. The battery system can be located onboard the freight railway vehicle and supply power to the electric motors, sensors 612, and other components (e.g., communication interface 610). One or more motors may be coupled to the axle or axles of railway vehicle 602 through a transmission system, which may include drive gears, belts, chains, or other mechanical components.

In some embodiments, the freight railway vehicle may also include a battery configured to supply power to the motor. The battery may be a rechargeable battery, such as a lithium-ion battery, a nickel-metal hydride battery, or a lead-acid battery. The battery may be configured to store electrical energy and deliver this energy to the motor. The battery may be charged by an onboard generator, an external power source, or through regenerative braking. In some cases, the battery may also supply power to sensors 612 and computing system 604. Different energy sources may be used to provide power to sensors 612 and computing system 604. For example, a battery may be used for portable applications, or the system could be powered directly from the electrical system of railway vehicle 602. The choice of energy source may depend on various factors, such as the power requirements of each sensor, computing system 604, the availability of power sources, and the operational constraints of railway vehicle 602.

In some examples, system 600 may be used to provide comprehensive, continuous monitoring of the rail network, including areas that may be challenging for human inspectors to access frequently. By collecting data over time, system 600 may enable historical trend analysis, identifying gradual changes in track conditions that might not be apparent during individual manual inspections. This continuous stream of data allows for prioritized maintenance activities, focusing efforts on areas requiring immediate attention based on objective assessments. By potentially decreasing the frequency of manual inspections requiring track closures, system 600 may reduce track downtime and minimize disruptions to railway operations. For instance, continuous monitoring can enhance safety by quickly identifying sudden changes in track conditions that may pose immediate risks, allowing for rapid response and mitigation. System 600 may be configured to detect and report on track conditions to assist in demonstrating compliance with regulatory requirements and industry standards.

In some examples, system 600 may contribute to improved railway safety and efficiency in various ways. For instance, system 600 may enable the implementation of dynamic speed restrictions based on real-time track conditions, potentially reducing accident risks while optimizing train speeds where possible. By identifying early signs of track degradation, system 600 may allow for timely interventions before issues impact operations. In addition, integration with existing railway management systems may enable the exchange of valuable data for decision-making and long-term infrastructure planning, helping operators optimize maintenance schedules, reduce downtime, and potentially extend track infrastructure lifespan.

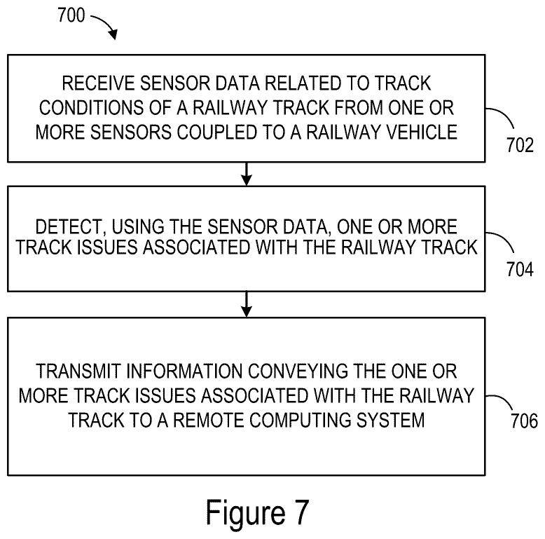

FIG. 7 is a flowchart of a method for performing automatic track inspection and evaluation. Method 700 represents an example method that may include one or more operations, functions, or actions, as depicted by one or more of blocks 702, 704, and 706, each of which may be carried out by any of the systems, devices, and/or railway vehicles shown in FIGS. 1-6, among other possible systems.

Those skilled in the art will understand that the flowcharts described herein illustrate functionality and operations of certain implementations of the present disclosure. In this regard, each block of the various flowcharts may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as may be understood by those reasonably skilled in the art.

At block 702, method 700 involves receiving sensor data related to track conditions of a railway track from one or more sensors coupled to a railway vehicle as the railway vehicle travels on the railway track. A computing system may receive the sensor data from the sensors. In some examples, the computing system is located onboard the railway vehicle, positioned remotely from the railway vehicle, or comprises a combination of onboard and remote computing devices.

Various types of sensors may be strategically positioned to capture different aspects of the track conditions. Some example sensors include cameras, lasers, LiDAR, infrared sensors, radar, ultrasound sensors, inertial measurement units (e.g., accelerometers and gyrometers), and microphones, among other options. Each sensor type may provide data that, when combined, offers a comprehensive view of the track's state. The array of sensors used can be changed to include other types of sensors within examples.

The sensors can be integrated onto railway vehicles in various ways, depending on the vehicle design and operational requirements. In some cases, one or multiple sensors may be built directly into new train vehicles during manufacturing, with dedicated mounting points and internal wiring for seamless integration. For example, accelerometers and gyroscopes might be incorporated into the axle boxes or bogie frames, while cameras, radar, and/or LiDAR sensors could be installed in purpose-built housings on the undercarriage or front of the train. In other cases, existing train vehicles can be retrofitted with sensor systems using external mounting brackets, magnetic attachments, adhesives, and/or custom-designed housings. These retrofit solutions may include weatherproof enclosures to protect sensitive equipment, and may utilize wireless communication to transmit data to a central processing unit, minimizing the need for extensive rewiring. In some retrofit scenarios, sensors might be installed in modular units that can be easily attached and detached for maintenance or upgrades. Advanced retrofit designs might even include retractable sensor arrays that can be deployed during inspection runs and retracted during normal operations to protect the equipment from damage.

In some examples, the railway vehicle is a freight railway vehicle with the sensors retrofitted onto the freight railway vehicle using mechanical connections. The freight railway vehicle may also include a motor and a battery with the motor configured to provide torque to rotate at least one axle of the freight railway vehicle.

In some examples, one or multiple high-resolution cameras may be positioned on the railway vehicle and used to capture visual data of the track and its surroundings. For instance, a set of cameras may be positioned on the railway vehicle with field of views that capture the track from multiple angles, allowing for detailed inspection of rail surfaces, railway ties, and fasteners. The visual data may be used to detect visible defects such as cracks, missing bolts, or vegetation overgrowth.

In some examples, the computing system may receive image data from an optical camera configured to use different spectral sensitivities to image the railway track as the railway vehicle travels on the railway track. The computing system may use the image data across the spectral sensitivities to detect a heat anomaly corresponding to one or more components of the railway. The computing system may also identify one or more track issues based on the detected heat anomaly corresponding to the one or more components of the railway track. In other examples, the computing system may receive image data from an optical camera representing an environment of the railway track, which can then be used to evaluate a condition of one or more track-side signs, signals, and markers located in the environment of the railway track.

Infrared sensors may be used to measure the temperature of various track components. Unusual heat signatures may indicate problems with bearings, brakes, or other mechanical components. In some cases, infrared sensors may also help in detecting areas of high friction or stress on the rails. Likewise, thermal imaging cameras may be used to provide more detailed temperature mapping, potentially detecting overheating in rail components that could indicate excessive friction or impending failure.

In some examples, LiDAR sensors may be positioned on the railway vehicle and used to create precise 3D point clouds of the track and its immediate environment. This data may be used to measure track geometry, including gauge, alignment, and cross-level. LiDAR may also provide data that helps with detecting changes in ballast profile or encroachment of obstacles near the track. In some examples, the computing system may receive LiDAR data from one or more LiDAR units coupled to the railway vehicle and use the LiDAR data to determine a condition of a track bed and ballast associated with the railway track.

Accelerometers and gyrometers mounted on the railway vehicle's body or axles may be used to measure vibrations and movements as the train travels. These measurements may indicate track roughness, joint conditions, or areas of track settlement. Unusual vibration patterns may signal potential issues with track components or subgrade problems. As such, the computing system may receive accelerometer data from one or more accelerometers and/or data from one or more gyrometers coupled to the railway vehicle, which can be used to detect an abnormal vibration pattern in the data indicative of one or more track issues associated with the railway track.

In some examples, ultrasonic sensors may be used to inspect the internal structure of the rails. These sensors may detect internal flaws or wear patterns that are not visible from the surface, providing early warning of potential rail failures. Similarly, eddy current sensors may identify surface and near-surface defects in rails, including cracks and corrosion that are not visible to the naked eye.

Ground-penetrating radar (GPR) sensors may be positioned on the railway vehicle and used to detect subsurface issues in the track bed, such as water pockets, ballast fouling, or subgrade problems. This technology may be particularly useful for assessing the condition of the track foundation, which may increase overall track stability and performance. In some examples, the computing system may receive radar data from one or more ground-penetrating radar coupled to the railway vehicle. The computing system may then determine a condition of a track bed and ballast associated with the railway track based on the radar data.

Strain gauges may be used to measure the deformation of rails under load, which can help to assess rail integrity and identify areas of excessive stress. This data may be used for predicting potential rail failures and optimizing maintenance schedules.

In some examples, microphones may be used to capture acoustic data as the train moves along the track. Changes in the sound profile may indicate issues with wheel-rail interaction, loose components, or other anomalies. GPS receivers may provide precise location data, allowing the system to map collected sensor data to specific track segments. This geolocation information may be useful for accurately identifying and locating areas that require maintenance or further inspection.

Acoustic emission sensors may detect and localize developing cracks in rails by sensing the sound waves emitted during crack growth. This technology may provide early warning of rail defects before they become visible or detectable by other means. In some cases, laser profilometers may be used to measure precise rail profiles to detect wear patterns and gauge issues. This high-precision measurement may be useful for maintaining proper wheel-rail interaction and ensuring safe train operations. In some examples, moisture sensors may be used to detect water content in the ballast and subgrade, which can affect track stability. This information may be particularly valuable in areas prone to water-related track issues or during periods of heavy rainfall.

The data collection process may be continuous as the railway vehicle travels, with sensors constantly monitoring and recording information. The frequency of data capture may vary depending on the sensor type and the specific parameters being measured. For instance, accelerometer data may be sampled at a high frequency to capture subtle vibrations, while visual data from cameras may be captured at regular intervals or triggered by specific events. Sensors can also be used to capture measurements corresponding to surrounding areas of the environment, including nearby tracks, other vehicles, and other information. In some cases, sensors may capture information while the railway vehicle is stopped.

In some cases, the system may adjust its data collection parameters based on the railway vehicle's speed, track type, or known problem areas. For example, the system may increase the sampling rate when passing through curves, bridges, or sections with a history of issues. The generated data may be initially processed onboard the railway vehicle to reduce data volume and highlight potential areas of concern. This processed data may then be transmitted to a central system for more detailed analysis and integration with historical data.

At block 704, method 700 involves detecting one or more track issues associated with the railway track. One or more processing units may analyze the sensor data to identify track issues and degradation over time corresponding to the railway track. In some cases, various types of issues may be detected during analysis, such as ballast washout, deteriorating rail ties, missing spikes, broken joints, warped track, and/or rail pitting. Other types of railway issues can be detected and analyzed by performing method 700.

One or multiple processing units may use the sensor data to detect and potentially identify issues. In some examples, an onboard computing device may analyze incoming sensor data generated by one or multiple sensors in real-time as the railway vehicle travels along the track. For instance, the computing device may receive real-time sensor data from various onboard sensors and apply filtering and noise reduction techniques to clean and enhance the raw data, isolating relevant information from noise. The computing device may then use pre-programmed algorithms and/or machine learning models to analyze the processed data for immediate track condition assessment. For example, accelerometer data may be analyzed in real-time by an onboard computing system to detect sudden spikes or unusual vibration patterns that could indicate track defects while image data is processed using computer vision. The computing system may then associate potential track defects with the current location of the railway vehicle.

In some examples, the analysis process for track condition assessment may involve interconnected steps and techniques. For instance, an onboard computing system and/or a remote computing system may initially perform data preprocessing and fusion, which may involve synchronizing and combining data from various sensors to create a comprehensive representation of track conditions. For instance, visual data from cameras may be overlaid with LiDAR point clouds to generate detailed 3D models of the track and its surroundings. This fusion allows for more accurate detection of issues that might not be apparent from a single data source.

Analysis may further involve using machine learning and pattern recognition. For instance, one or more machine learning models, trained on large datasets of known track issues and normal operating conditions, may be used to detect patterns and anomalies. For example, convolutional neural networks might analyze visual data to identify defects such as missing fasteners, rail surface defects, or vegetation encroachment. Other algorithms may analyze vibration data from accelerometers to detect subtle changes in track geometry or subgrade issues.

Spectral analysis techniques may be applied to vibration and acoustic data to identify specific types of track defects. Different issues may produce characteristic frequency signatures. For instance, a periodic vibration at a specific frequency might indicate a developing wheel flat, while a broadband increase in noise might suggest deteriorating rail surface conditions.

In some examples, a computing system may compare current data against historical baselines for each track segment to identify gradual degradation over time. This could help detect slow increases in track roughness over several months, indicating developing issues with ballast condition or subgrade settlement. The analysis may incorporate contextual information such as track geometry, traffic patterns, and environmental conditions. A computing system may adjust its thresholds for acceptable track conditions based on whether a section is on a curve, bridge, or straight track, and consider factors like recent maintenance activities, weather conditions, or seasonal variations.

In some examples, edge computing techniques may be used, which may involve running simplified versions of machine learning models directly on the onboard system and/or locally at the sensor. This may allow for real-time detection of track anomalies without requiring constant communication with a central system. For optical or LiDAR data, computer vision techniques may be applied to detect visible defects or measure track geometry. In addition, the computing system may use statistical methods or machine learning to identify unusual patterns in the data that deviate from normal track conditions. The detection process may consider factors such as vehicle speed, track location, and environmental conditions to accurately interpret sensor data.

In some examples, one or more predictive models may be used to forecast future track conditions based on current data and historical trends. These models may use techniques such as time series analysis or regression to project how quickly a developing issue might progress, allowing maintenance teams to prioritize repairs and schedule interventions proactively.

In some examples, a computing system may perform automated compliance checks against regulatory standards, flagging any conditions that fall outside acceptable parameters defined by bodies such as the FRA and AAR track inspection requirements. This process may involve maintaining an up-to-date database of regulatory standards and requirements from these relevant authorities. As the system collects and analyzes track condition data, the computing system may automatically compare various parameters against the established regulatory thresholds. In some cases, these parameters may include track geometry measurements (such as gauge, alignment, and cross level), rail wear and profile, track structure components (like railway ties, fasteners, and ballast condition), signal system functionality, and/or bridge and tunnel conditions.

The computing system may continuously monitor these parameters, checking if they fall within acceptable ranges defined by the regulations. When a parameter exceeds regulatory limits, the computing system may automatically flag the issue. This flagging process may involve generating an alert in the system, marking the specific location of the non-compliant condition, and categorizing the severity of the violation. The computing system may then generate automated reports detailing any compliance issues, including the nature of the non-compliance, the specific regulation or standard that was violated, the location and extent of the issue, and recommended actions for addressing the problem.

Based on the severity and nature of the compliance issues, the computing system may prioritize them for maintenance and repair activities. Additionally, these automated compliance checks create a digital record of track conditions and compliance status, which can be useful for audits and regulatory inspections. By performing these automated compliance checks, the computing system may help railway operators maintain their infrastructure within regulatory standards, potentially improving safety and reducing the risk of penalties or operational restrictions due to non-compliance.

In some cases, the analysis may correlate data from multiple train passes over the same track section, helping distinguish between transient issues and persistent problems. This may involve obtaining and analyzing larger amounts of sensor data, which may be stored in memory locally onboard the railway vehicle and/or remotely from the railway vehicle.

In some examples, the analysis process may include automated categorization and prioritization of detected issues. For example, a detected rail crack might be classified as a high-priority issue requiring immediate attention, while a minor ballast irregularity might be flagged for future monitoring.

A computing system may generate immediate alerts for severe issues detected during travel, potentially triggering automatic speed restrictions or notifying train operators of imminent hazards. In some instances, the computing system may detect a sudden, severe vibration pattern consistent with a potential rail break or severe rail defect and reactively generate an alert. The alert may send a visual and audible warning to the train operator's console, indicating the nature and location of the suspected rail break. In some cases, the computing system may also automatically apply speed restrictions to the railway vehicle, reducing its speed to a safe level as it approaches the affected area. The computing system may also transmit an emergency alert to a central control center, providing details about the potential rail break and the railway's current location, which may also notify maintenance crews of the urgent need for inspection and potential repair at the specific track location.

In another example, the computing system may detect a large obstruction on the track ahead using one or more sensors, such as a combination of forward-facing cameras and LiDAR sensors. The computing system may trigger an urgent alert on the train operator's display, showing a visual representation of the obstruction and its distance from the train and may also initiate an automatic braking sequence if the obstruction is within a critical distance, helping to prevent a potential collision. In addition, the computing system may also send real-time imagery and data about the obstruction to a central control center for assessment and coordination of emergency response and/or broadcast an alert to other trains in the vicinity, warning them of the potential hazard and implementing network-wide speed restrictions in the affected area.

Analysis results may be presented in user-friendly formats such as interactive maps, trend graphs, or detailed reports, allowing maintenance personnel and decision-makers to quickly understand the current state of the track network and make informed decisions about maintenance and repair activities.

At block 706, method 700 involves transmitting the analyzed data to a remote computing system. For example, the computing system may transmit data indicating a location for each track issue associated with the railway track to the remote computing system. The location for each track may be determined based on GPS data received from a GPS receiver coupled to the railway vehicle. In some cases, the computing system may determine the location for each track issue of the one or more track associated with the railway track using a linear referencing system where each track issue's location is identified based on a distance from a known reference marker (e.g., mile marker) associated with the railway track.

In some examples, the computing system may aggregate sensor data related to track conditions of the railway track from the one or more sensors coupled to the railway during multiple trips by the railway vehicle on the railway track. The computing system may then assign one or more threshold ranges for segments of the railway track based on the aggregated sensor data. These threshold ranges may be used to evaluate new sensor data and identify anomalies that may be indicative of a track issue. As such, the computing system may adjust the speed of the railway vehicle during travel on one or more segments of the railway track based on the threshold ranges.

In some examples, the computing system may aggregate sensor data related to track conditions of the railway track from sensors coupled to the railway vehicle during multiple trips by the railway vehicle on the railway track. Based on the aggregated sensor data, the computing system may then estimate degradation over time using a machine learning model. The machine learning model may be trained to predict progressive damage over time.

In some examples, the remote computing system may aggregate and analyze data provided by multiple railway vehicles. The remote computing system may receive data uploads from numerous railway vehicles operating across the network. This data may be transmitted in real-time or batch-uploaded when vehicles return to depots or pass through areas with strong connectivity. For instance, the remote computing system may store this data in large-scale databases or data lakes, organizing it by track segment, time, and other relevant parameters. The remote computing system may then apply advanced data processing techniques to clean, normalize, and prepare the data for analysis. Machine learning algorithms may be used to analyze this aggregated data, identifying patterns and trends that may not be apparent from a single vehicle's data. For example, the remote computing system may detect gradual degradation of track segments over time by comparing data from multiple passes by different vehicles.

In some examples, the remote computing system may perform cross-correlation analyses, comparing data from different types of railway vehicles or from different seasons to identify how various factors affect track conditions. The remote computing system may also integrate external data sources, such as weather information or maintenance records, to provide context for the sensor data. Predictive analytics models may also be used to forecast future track conditions based on historical trends and current data. These models may help in prioritizing maintenance activities and optimizing resource allocation across the network.

The remote computing system may generate comprehensive reports and visualizations, providing network-wide views of track conditions, highlighting areas of concern, and suggesting maintenance schedules. It may also feed data back to onboard systems, updating their analysis parameters based on network-wide insights. By combining onboard analysis for immediate safety concerns with remote analysis for long-term planning and network-wide optimization, these systems may provide a comprehensive approach to track inspection and maintenance.

In addition, transmitting the analyzed data to a remote computing system may involve several processes and considerations to ensure efficient and secure data transfer. The transmission process may begin with data prioritization and compression. In some cases, information, such as detected severe track defects or safety-related issues, may be flagged for immediate transmission. Less urgent data may be queued for later transfer. The system may employ various compression algorithms to reduce the data volume without loss of information, optimizing bandwidth usage. Multiple communication channels may be utilized to ensure reliable data transmission. The system may use a combination of cellular networks, satellite communications, and trackside Wi-Fi access points. For example, when the train is within range of a high-speed trackside network, it may prioritize large data transfers. In areas with limited connectivity, the system may switch to satellite communication for transmitting updates.

The transmission may occur in real-time or in batches, depending on the urgency of the information and available bandwidth. Real-time transmission may be used for alerts, such as detected rail breaks or track obstructions, allowing for immediate response. Non-critical data, such as long-term degradation trends, may be transmitted in larger batches during periods of high bandwidth availability or when the train is stationary. To ensure data integrity and security, the system may employ encryption protocols and error-checking mechanisms. For instance, each data packet may be encrypted using advanced encryption standards before transmission. Checksums or hash functions may be used to verify that the data received by the remote system matches what was sent, with automatic retransmission requests for any corrupted data.

The system may implement adaptive transmission strategies based on network conditions. In areas of poor connectivity, it may reduce the data transmission rate or switch to sending summary data. As network conditions improve, it may then transmit more detailed information or any backlogged data. In some cases, the system may employ edge computing techniques, performing initial data analysis onboard the train and transmitting the results or anomalies to the remote system. This approach may reduce the volume of data to be transmitted, while still providing timely and relevant information to the remote system.

The transmission process may also include metadata tagging. Each transmitted data packet may be tagged with relevant information such as timestamp, GPS coordinates, train ID, and sensor types. This metadata may help in organizing and analyzing the data at the remote computing system, allowing for easy correlation with other data sources and historical records. To handle potential communication failures, the system may implement a store-and-forward mechanism. If a connection to the remote system cannot be established, the analyzed data may be stored locally on the train. Once communication is restored, the system may automatically forward the stored data, ensuring no information is lost due to temporary connectivity issues. The system may also be designed to handle bi-directional communication. While primarily sending data to the remote system, it may also be capable of receiving updates or commands. For example, the remote system might send updated analysis parameters or request additional data from specific sensors based on initial findings.

The remote computing system that receives and processes the analyzed track inspection data may utilize the information in various ways to enhance railway operations, safety, and maintenance. The system may dynamically adjust train routes based on real-time track condition data. For instance, if severe track degradation is detected on a particular section, the system may reroute trains to alternate tracks or adjust schedules to allow for reduced speeds through the affected area.

By analyzing trends in track degradation over time, the system may forecast future maintenance tasks. This may allow for more efficient scheduling of maintenance crews and equipment, minimizing disruptions to regular train operations. In cases where some issues are detected, such as track obstructions or severe damage, the system may automatically alert emergency response teams and coordinate their deployment to the specific location.

The system may dynamically adjust speed limits for different track sections based on current conditions. For example, it may lower speed limits in areas with developing track issues or during adverse weather conditions. By prioritizing detected issues, the system may optimize the allocation of maintenance resources. It may direct crews and equipment to address some problems first (e.g., critical issues), ensuring efficient use of available resources.

After repairs are completed, the system may use subsequent inspection data to verify the effectiveness of the maintenance work. This may help ensure that repairs meet quality standards and identify any issues that may require follow-up. By analyzing patterns of track degradation across the network, the system may inform long-term decisions about infrastructure investments, such as identifying sections that may require major overhauls or upgrades.

The system may automatically generate reports on track conditions for regulatory compliance purposes, flagging any areas that fall outside of acceptable parameters and initiating corrective actions.

Based on track condition data, the system may adjust train acceleration and braking profiles to optimize energy consumption while maintaining safe operations. For freight operations, the system may use track condition data to route heavier loads through sections with better track integrity, minimizing wear on more vulnerable sections. The system may correlate track condition data with weather forecasts to preemptively adjust operations in anticipation of weather-related impacts on track conditions. By integrating track condition data with information from other railway assets (e.g., signals, bridges), the system may optimize overall network performance and maintenance strategies.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

It should be understood that arrangements described herein are for purposes of example only. As such, those skilled in the art will appreciate that other arrangements and other elements (e.g. machines, apparatuses, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

1. A method comprising:
receiving, at a computing device, sensor data related to track conditions of a railway track from one or more sensors retrofitted onto a freight railway vehicle as the freight railway vehicle travels on the railway track, wherein the freight railway vehicle comprises an electric motor configured to rotate at least one axle of the freight railway vehicle and a battery system configured to power the electric motor, the computing device, and the one or more sensors;
detecting, by the computing device, using the sensor data, one or more track issues associated with the railway track; and
transmitting information conveying the one or more track issues associated with the railway track to a remote computing system, wherein the remote computing system is configured to aggregate information from a plurality of computing devices, and wherein each computing device from the plurality of computing devices is coupled on a given railway vehicle.

2. The method of claim 1, wherein receiving sensor data related to track conditions of the railway track comprises:
receiving accelerometer data from one or more accelerometers coupled to the railway vehicle; and
wherein detecting one or more track issues associated with the railway track comprises:
detecting an abnormal vibration pattern in the accelerometer data indicative of one or more track issues associated with the railway track.

3. The method of claim 1, wherein receiving sensor data related to track conditions of the railway track comprises:
receiving image data from a thermal imaging camera to image the railway track as the railway vehicle travels on the railway track; and
wherein detecting one or more track issues associated with the railway track comprises:
detecting, using the image data, a heat anomaly corresponding to one or more components of the railway track; and
identifying one or more track issues based on the detected heat anomaly corresponding to the one or more components of the railway track.

4. The method of claim 1, wherein receiving sensor data related to track conditions of the railway track comprises:
receiving LiDAR data from one or more LiDARs coupled to the railway vehicle; and
wherein detecting one or more track issues associated with the railway track comprises:
determining, based on the LiDAR data, a condition of at least one of a track bed or ballast associated with the railway track.

5. The method of claim 1, wherein receiving sensor data related to track conditions of the railway track comprises:
receiving image data from an optical camera representing an environment of the railway track; and
wherein detecting one or more track issues associated with the railway track further comprises:
evaluating, based on the image data, a condition of one or more track-side signs, signals, and markers located in the environment of the railway track.

6. The method of claim 1, wherein receiving sensor data related to track conditions of the railway track comprises:
receiving radar data from one or more ground-penetrating radar coupled to the railway vehicle; and
wherein detecting one or more track issues associated with the railway track comprises:
determining, based on the radar data, a condition of at least one of a track bed or ballast associated with the railway track.

7. The method of claim 1, wherein transmitting information conveying the one or more track issues associated with the railway track to the remote computing system comprises:
transmitting data indicating a location for each track issue associated with the railway track to the remote computing system, wherein the location is determined based on GPS data received from a GPS receiver coupled to the railway vehicle.

8. The method of claim 1, further comprising:
determining a the location for each track issue of the one or more track issues associated with the railway track using a linear referencing system, wherein each location is identified based on a distance from a known reference marker associated with the railway track.

9. The method of claim 1, further comprising:
aggregating sensor data related to track conditions of the railway track from the one or more sensors coupled to the railway vehicle during a plurality of trips by the railway vehicle on the railway track; and
assigning one or more threshold ranges for a plurality of segments of the railway track based the aggregated sensor data.

10. The method of claim 9, further comprising:
adjusting a speed of the railway vehicle during travel on one or more segments of the plurality of segments of the railway track based on the one or more threshold ranges.

11. The method of claim 1, further comprising:
aggregating sensor data related to track conditions of the railway track from the one or more sensors coupled to the railway vehicle during a plurality of trips by the railway vehicle on the railway track; and
estimating, based on the aggregated sensor data, degradation over time using a machine learning model, wherein the machine learning model is trained to predict progressive damage over time.

12. The method of claim 1, wherein detecting one or more track issues associated with the railway track comprises:
identifying the one or more track issues using a machine learning model, wherein the machine learning model is trained to identify different types of track issues.

13. The method of claim 12, wherein the machine learning model is further trained to detect compliance with Federal Railroad Administration (FRA) and Association of American Railroads (AAR) track inspection requirements.

14. (canceled)

15. The method of claim 1, wherein detecting one or more track issues associated with the railway track comprises:
performing, using a model, spectral analysis on vibration data to identify one or more track issues, wherein the model is trained to identify a plurality of track issues based on a plurality of frequency signatures, and wherein each frequency signature represents a given track issue.

16. The method of claim 1, further comprising:
based on detecting the one or more track issues, identifying each track issue of the one or more track issues using a model, wherein the model is trained to use sensor data to identify a plurality of track issues; and
wherein transmitting information conveying the one or more track issues associated with the railway track to the remote computing system comprises:
transmitting information conveying a location and an identification for each track issue of the one or more track issues.

17. A system comprising:
one or more sensors retrofitted onto a freight railway vehicle; and
a computing device configured to:
receive sensor data related to track conditions of the railway track from the one or more sensors as the freight railway vehicle travels on the railway track, wherein the freight railway vehicle comprises an electric motor configured to rotate at least one axle of the freight railway vehicle and a battery system configured to power the electric motor, the computing device, and the one or more sensors;
detect, by the computing device, using the sensor data, one or more track issues associated with the railway track; and
transmit information conveying the one or more track issues associated with the railway track to a remote computing system, wherein the remote computing system is configured to aggregate information from a plurality of computing devices, and wherein each computing device from the plurality of computing devices is coupled on a given railway vehicle.

18. (canceled)

19. (canceled)

20. A non-transitory computer readable medium configured to store instructions, that when executed by a computing system comprising one or more processors, causes the computing system to perform operations comprising:
receiving sensor data related to track conditions of a railway track from one or more sensors retrofitted onto a freight railway vehicle as the freight railway vehicle travels on the railway track, wherein the freight railway vehicle comprises an electric motor configured to rotate at least one axle of the freight railway vehicle and a battery system configured to power the electric motor, the computing system. and the one or more sensors;
detecting, by the computing system, using the sensor data, one or more track issues associated with the railway track; and
transmitting information conveying the one or more track issues associated with the railway track to a remote computing system, wherein the remote computing system is configured to aggregate information from a plurality of computing devices, and wherein each computing device from the plurality of computing devices is coupled on a given railway vehicle.

21. The method of claim 1, further comprising:
adjusting, by the computing device, a speed of the freight railway vehicle based on the one or more detected track issues.
